(19) United States
(12) Patent Application Publication
(10) Pub. No.: US 2013/0209811 A1
(43) Pub. Date: Aug. 15, 2013

(54) METHOD FOR DEPOSITING A BIOCIDAL COATING ON A SUBSTRATE

(71) Applicants: Roel Dams, Mol (BE); Sabine Paulussen, Antwerpen-Deurne (BE); Dirk Vangeneugden, Opgrimbie (BE); David Sheel, Manchester (GB)

(72) Inventors: Roel Dams, Mol (BE); Sabine Paulussen, Antwerpen-Deurne (BE); Dirk Vangeneugden, Opgrimbie (BE); David Sheel, Manchester (GB)

(21) Appl. No.: 13/806,663

(22) PCT Filed: Jul. 7, 2011
(86) PCT No.: PCT/EP2011/061551

§ 371 Date: Mar. 27, 2013

(30) Foreign Application Priority Data
Jul. 7, 2010 (EP) 10168733.3

(51) Int. Cl. B05D 1/08

(52) U.S. Cl. CPC B05D 1/08
USPC 428/446; 427/447

(57) ABSTRACT

A method produces a biocidal coating on a substrate, by a flame assisted chemical vapour deposition and a plasma assisted chemical vapour deposition step. In a first step, a biocidal material is deposited onto the substrate, possibly in combination with a first coating forming material. The second step provides a coating forming material onto the first layer, possibly in combination with a second biocidal material. The first step can be a flame assisted CVD step and the second step a plasma assisted CVD step or vice versa.

### FIELD OF THE INVENTION

The present invention is related to the coating of substrates through the use of flame-assisted and plasma-assisted coating techniques. In particular the invention is related to the deposition of biocidal coatings.

### STATE OF THE ART

There has been an increased awareness of the health risks caused by certain types of pathogenic micro-organisms, which may cause infection through physical contact with objects carrying such organisms. In hospitals, the so-called Health Care Associated Infections (HCAI) are a known problem, but also in other areas such as food handling or food storage, there is a growing need for materials with biocidal properties.

The pathogenic micro-organisms that are of most widespread concern are: Meticillin Resistant Staphylococcus aureus (MRSA), Clostridium difficile and Norovirus. Other micro-organisms such as Glycopeptide Resistant Enterococci (GRE), Pseudomonas species and Acinetobacter species are similarly very important in specialised clinical units. There is also an emerging threat from Extended Spectrum Beta-lactamase (ESBL) producing Escherichia coli. The reservoirs and pathways of infection for these micro-organisms are multifactorial but environmental contamination has a major role.

The use of plasma techniques for producing biocidal coatings has been documented. In WO2005/110626, a method is described for forming an active material containing coating on a substrate, comprising the steps of: i) introducing one or more gaseous or atomised liquid and/or solid coating-forming materials which undergo chemical bond forming reactions within a plasma environment and one or more active materials which substantially do not undergo chemical bond forming reactions within plasma environment, into an atmospheric or low pressure non-thermal equilibrium plasma discharge and/or an excited gas stream resulting therefrom, and ii) exposing the substrate to the resulting mixture of atomised coating-forming material and at least one active material which are deposited onto the substrate surface to form a coating.

In the above cited reference, the active material may contain various biocidal materials. It may consist of nano-particles of such materials. For example, the active material may comprise Ag or Cu particles, which are known for their biocidal activity.

### AIMS OF THE INVENTION

Despite developments such as described above, there is an ongoing need to produce biocidal coatings with higher effectiveness, primarily in terms of higher bacterial kill rates. The present invention aims to provide an answer to that need.

### SUMMARY OF THE INVENTION

The invention is related to a method as disclosed in the appended claims.

According to a first embodiment, the invention is related to a method for producing a biocidal coating on a substrate, comprising the subsequent steps of:
providing a substrate,
subjecting the substrate to a flame-assisted chemical vapour deposition, by exposing the substrate to a flame or the gas stream resulting therefrom and by introducing a first biocidal material into said flame or the reactive gas stream resulting therefrom, and optionally by introducing a first coating-forming material into the flame or the gas stream resulting therefrom, said first coating forming material being introduced simultaneously with or after said first biocidal material,
subjecting the substrate to a plasma-assisted chemical vapour deposition at atmospheric or intermediate pressure, by exposing the substrate to a plasma discharge or the reactive gas stream resulting therefrom and by introducing a second coating-forming material into said discharge or the reactive gas stream resulting therefrom.

In the first embodiment, a second biocidal material may be introduced into the plasma discharge or the reactive gas stream resulting therefrom, said second coating forming material being introduced simultaneously with or after said second biocidal material.

According to a second embodiment, the invention is related to a method for producing a biocidal coating on a substrate, comprising the subsequent steps of:
providing a substrate,
subjecting the substrate to a plasma-assisted chemical vapour deposition at atmospheric or intermediate pressure, by exposing the substrate to a plasma discharge or the reactive gas stream resulting therefrom and by introducing a first biocidal material into said discharge or the reactive gas stream resulting therefrom, and optionally by introducing a first coating-forming material into said discharge or the gas stream resulting therefrom, said first coating forming material being introduced simultaneously with or after said first biocidal material,
subjecting the substrate to a flame-assisted chemical vapour deposition, by exposing the substrate to a flame or the gas stream resulting therefrom and by introducing a second coating-forming material into the flame or the gas stream resulting therefrom.

In the second embodiment, a second biocidal material may be introduced into the flame or the reactive gas stream resulting therefrom, said second coating forming material being introduced simultaneously with or after said second biocidal material.

In the first and second embodiment, said first and/or said second coating-forming material may comprise an organosilicon precursor. Said organosilicon precursor may be APED or TEOS.

In the first and second embodiment, the first and/or the second coating-forming material may have itself biocidal properties. In the latter case, the coating forming material deposited by PACVD may be chosen from the group consisting of: allyl amine, butylamine, hexamethyldisilazane, 3-aminopropyltriethoxysilane, N-(2-Aminoethyl)-3-aminopropyltriethoxysilane, 3-aminopropyltrimethoxysilane, triazine, 2,4-diamino-6-diallylamino-1,3,5-triazine, dimethylhydantoin, methyl quaternized N,N-dimethylamino-O-ethyl-methacrylate, methyl quaternized N,N-benzyl-methylamino-O-ethyl-methacrylate, diallyldimethylammonium chloride, quaternized vinylbenzylchloride, tetra-n-butyl ammonium chloride, 3-((trimethoxysilyl)propyl)octadecyldimethylammonium chloride, diallyldisulphide, mercaptopropyl trimethoxysilane, mercaptopropyl triethoxysilane.

In the first and second embodiment, the first and/or the second biocidal material may consist of or comprise one or more of the following: silver, copper, titanium, mercury, tin, lead, bismuth, chromium, cobalt, nickel, tallium, cadmium, zinc, magnesium, silver nitrate, copper sulfate, copper nitrate, silver sulphate.

In the method of the invention, said plasma discharge may be a dielectric barrier discharge (DBD).

In a specific version of the first and second embodiment, at least the second coating forming material does not have biocidal properties, or does not comprise a biocidal component.

According to the first embodiment, the invention is equally related to a substrate comprising on its surface a biocidal coating, said coating comprising:
on an in contact with said substrate surface, a first coating portion obtainable by flame-assisted chemical vapour deposition (FACVD), said first coating portion comprising a first biocidal material,
said first coating portion optionally comprising a coating material covering one or more areas comprising said biocidal material or said biocidal material being incorporated into said coating material,
on and in contact with said first coating portion, a second coating portion the second portion being obtainable by plasma-assisted chemical vapour deposition (PACVD), the second coating portion comprising a coating material.

In the first embodiment, the second coating portion may further comprise a second biocidal material.

According to the second embodiment, the invention is equally related to a substrate comprising on its surface a biocidal coating, said coating comprising:
on an in contact with said substrate surface, a first coating portion obtainable by plasma-assisted chemical vapour deposition (PACVD), said first coating portion comprising a first biocidal material,
said first coating portion optionally comprising a coating material covering one or more areas comprising said biocidal material or said biocidal material being incorporated into said coating material,
on and in contact with said first coating portion, a second coating portion the second portion being obtainable by flame-assisted chemical vapour deposition (FACVD), the second coating portion comprising a coating material.

In the second embodiment, the second coating portion may further comprise a second biocidal material.

In a specific version of the first and the second embodiment, the coating material of the second coating portion does not have biocidal properties.

The invention is also related to the use of the method of the invention for giving biocidal properties to a substrate.

### BRIEF DESCRIPTION OF THE DRAWINGS

FIG. 1 illustrates a schematic set-up for performing a plasma-assisted chemical vapour deposition (PACVD) step based on the dielectric barrier discharge (DBD) technique, which can be glow discharge or filamentary discharge, usable in the present invention.

FIGS. 2a and 2b illustrate further installations for applying in-line PACVD in a DBD deposition.

FIG. 3 illustrates the basic components of a flame-assisted chemical vapour deposition (FACVD) installation usable in the invention.

FIG. 4 shows a comparative set of test results illustrating the Log 10 viable germ count on 5 coated surfaces, three of which were coated according to methods of the invention.

### DETAILED DESCRIPTION OF PREFERRED EMBODIMENTS OF THE INVENTION

The invention is related to methods for depositing coatings on a substrate, involving biocidal materials and coating forming materials. In the context of the present invention, a ‘coating forming material’ (often also referred to as a ‘precursor’) is defined as a material comprising chemical components which when deposited on a surface are capable of forming covalent bonds, in order to form a coherent coating layer. ‘Biocidal materials’ are defined as materials with active anti-bacterial and/or anti-fungal properties, which can be incorporated in a coating by forming reversible chemical bonds or physical interactions. Coating forming materials which are applicable in the invention may also have biocidal properties themselves.

In the following, when it is said that a coating forming material is ‘deposited on the substrate’, this means that a coating is formed as a consequence of the introduction of the coating forming material into an FACVD flame or afterglow or a plasma discharge or afterglow. In most cases, the coating material is different from the coating forming material, as the coating forming material breaks down into its substituent components which undergo chemical reactions. For example, deposition of the coating forming material TEOS by FACVD leads to a SiO₂ coating.

The present description also refers to a ‘biocidal material’ being introduced into an FACVD flame or afterglow or a plasma discharge or afterglow. In most cases, the biocidal material is not introduced in pure form, but as part of a chemical compound—for example, the biocidal material Ag may be introduced in the form of AgNO3 dissolved in water, leading to a Ag-containing coating on the substrate.

The invention discloses a method for depositing a biocidal coating on a substrate in two steps, an FACVD step and a PACVD step or vice versa. According to a first embodiment, a first coating step is performed by flame-assisted chemical vapour deposition (FACVD) on a substrate, a first biocidal material being supplied to the substrate in said first step, possibly in combination with the deposition of a first coating forming material. Either the biocidal material is deposited first onto the surface, and the coating forming material is deposited on top of the biocidal material, or the biocidal and coating forming materials are deposited simultaneously on the substrate. Then a second coating step is applied on the substrate, the second step taking place by plasma-assisted CVD (PACVD) at atmospheric or intermediate pressure (about 1 mbar to about 1 bar), wherein a second coating forming material is deposited on the FACVD layer, possibly in combination with a second biocidal material. Either the second biocidal material is deposited first onto the FACVD layer and the second coating forming material is deposited on top of the second biocidal material, or the second biocidal material and second coating forming material are deposited simultaneously on the FACVD layer.

According to a second embodiment, a first coating step is performed by plasma-assisted CVD (PACVD) at atmospheric or intermediate pressure (about 1 mbar to about 1 bar) on a substrate, a first biocidal material being supplied to the substrate in said first step, possibly in combination with the deposition of a first coating forming material. Either the biocidal material is deposited first onto the surface, and the coating forming material is deposited on top of the biocidal material, or the biocidal and coating forming materials are deposited simultaneously on the substrate. Then a second coating step is applied on the substrate, the second step taking place by flame-assisted CVD (FACVD), wherein a second coating forming material is deposited on the PACVD layer, possibly in combination with a second biocidal material. Either the second biocidal material is deposited first onto the PACVD layer and the second coating forming material is deposited on top of the second biocidal material, or the second biocidal material and second coating forming material are deposited simultaneously on the PACVD layer.

The following detailed description and the examples are based on the first embodiment wherein the FACVD step precedes the PACVD step. All details given hereafter are applicable to the second embodiment as well, i.e. the description and examples given with respect to the PACVD step as the second step (first embodiment) are applicable without change to the PACVD-step applied as the first step (first embodiment). Likewise, the description and examples given with respect to the FACVD step as the first step (first embodiment) are applicable without change to the FACVD-step applied as the second step (second embodiment.

FACVD in the context of the present invention includes any deposition method involving a flame obtained by the supply and ignition of a combustible component. What is known for example in FACVD is the use of a propane/oxygen mixture.

PACVD in the context of the present invention includes deposition techniques involving a plasma discharge obtained by applying an electrical field, possibly in the presence of a dielectricum, as is known by the skilled person (A. Fridman and L. A. Kennedy, Taylor and Francis books, “Plasma Physics and Engineering”). In the latter case, the plasma discharge normally takes place at lower temperatures than by using FACVD. Examples of PACVD are dielectric barrier discharge (DBD) or corona discharge.

Any known technique that falls under the above definitions of FACVD and PACVD may be used in the method of the invention. The FACVD step involves the introduction of a first biocidal material into the flame or into the reactive gas stream resulting therefrom. As a result, biocidal materials are deposited on the substrate. Possibly, a first coating-forming material is also introduced, which may result in a coating material with biocidal materials incorporated therein, i.e. bound by a reversible chemical bond to the coating forming material, or physically connected (without chemical bonds) to the coating forming material (e.g. particles of biocidal material embedded in the coating). The first biocidal material may be mixed with said coating forming material before introduction of the mixture into the flame. In the alternative, the first biocidal material may be introduced via a separate means (e.g. a separate atomizer), prior to or simultaneously with the first coating-forming material.

The PACVD step requires the introduction of a second coating forming material into a plasma discharge or into the reactive gas stream resulting therefrom, possibly in combination with a second biocidal material. The first and second coating forming materials may be any suitable material known in the art. They may be the same material or different materials. The coating forming material applied in the FACVD-step may comprise organosilicon precursors for producing Silicon oxide (SiO₂) layers, e.g. Tetraethylortosilicate (TEOS). For the same purpose, PACVD may be applied with organosilicon precursors such as aminopropyltriethoxysilane (APED).

According to an embodiment, at least the second coating forming material does not have biocidal properties, or does not comprise a biocidal component, as it is the case for TEOS and APED, which lead to a SiO2 coating by FACVD or PACVD respectively. According to another embodiment, the first and second coating forming materials may themselves have biocidal properties. A typical biocidal coating forming material suitable for use in PACVD is an amine, such as in allyl amine, butylamine, hexamethyldisilazane, 3-aminopropyltriethoxysilane, N-(2-Aminoethyl)-3-aminopropyltriethoxysilane, 3-aminopropyltrimethoxysilane, triazine, 2,4-diamino-6-diallylamino-1,3,5-triazine, dimethylhydantoin. Another biocidal coating forming material suitable for use in PACVD is an ammonium salt such as in methyl quaternized N,N-dimethylamino-O-ethyl-methacrylate and methyl quaternized N,N-benzyl-methylamino-O-ethyl-methacrylate, diallyldimethylammonium chloride, quaternized vinylbenzylchloride, tetra-n-butyl ammonium chloride, 3-((trimethoxysilyl)propyl)octadecyldimethylammonium chloride. Sulphur containing compounds are also known for their biocidal activity and can be applied in PACVD. Examples are diallyldisulphide, mercaptopropyl trimethoxysilane, mercaptopropyl triethoxysilane.

In the FACVD step, the coating forming material can for example be one of the following: TEOS, Tin tetrachloride, vanadyl acetylacetonate, vanadium tetrachloride, titanium tetrachloride, titanium tetra isopropoxide. In the alternative the precursor may also be anti-bacterial in itself, e.g. Titanium based precursors (which then forms Titanium oxide).

Essentially any type of substrate can be coated by the method of the invention. Examples are: polyester-coated or lacquered steel panels for use in hospital environments, steel panels for air-conditioning applications, plastics such as e.g. plastic foils for packaging in the food industry, textiles for use in bandages, wood for use in garden furniture, glass, etc. The substrate onto which the method of the invention is applied does not need to have a previously applied CVD-coating, such as Silicon oxide coating on its surface. It is known to apply a multilayered biocidal coating onto such a SiO₂ layer, as described in “Highly bioactive silver and silver/titania composite films grown by chemical vapour deposition”, Brook et al, Journal of Photochemistry and photobiology A: Chemistry 187 (2007) 53-63. In this technique, the previously applied SiO₂ layer acts as a diffusion barrier. In a preferred embodiment of the method according to the present invention, the substrate is not provided with such a diffusion barrier layer.

The first and second biocidal material may comprise or consist of metals such as silver, copper, titanium, mercury, tin, lead, bismuth, chromium, cobalt, nickel, tallium, cadmium, zinc, magnesium. Also metal salts (such as copper nitrate, copper sulphate, silver sulphate) or metal oxides might be used. Biocidal metals can also be injected in the form of metal complexes (preferably complexes of metals cited hereabove).

The first and second biocidal material can also be an organic compound. Examples are chitosan, cetylpiridiniumchloride, benzoic acid, sodium benzoate, lactoferrin, triclosan, bronopol, garlic oil, zosteric acid, furanone, oxybisphenoxarsine, n-octyl-isothiazolinone, 2-benzisothiazolin-3-on (BIT), 2-methyl-4-isothiazolin-3-on (MIT), 2,2-dibromo-3-nitrilopropionamide, 1,3-Dichloro-5,5-dimethylhydantoin, benzalkonium chloride, benzethonium chloride, cetylpirydinium chloride, cetrimonium chloride, tetraethyl ammonium bromide. Or the first and second biocidal material may comprise or consist of antibiotics, such as for example, tetracycline, levofloxacin, gentamicin, gatifloxacin, dodecyl benzene sulphonate, dodecyl-di(aminoethyl)-glycine. Other organic biocides are enzymes such as lysozyme, glucose oxidase, protease. The lists above give an overview of available biocidal materials, but the invention is not limited to these materials.

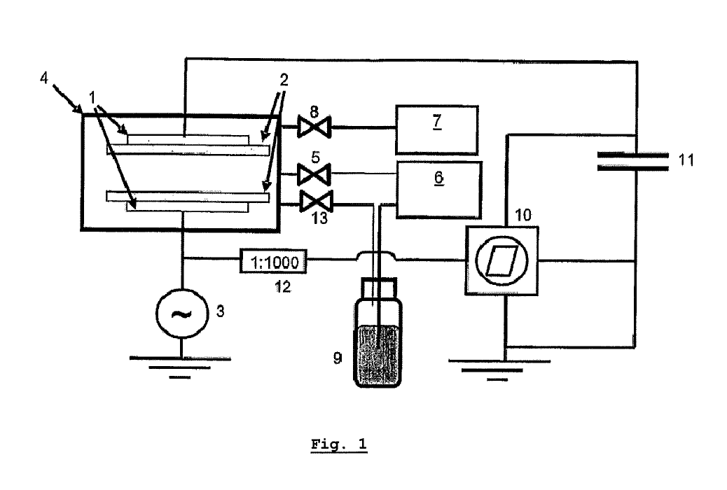

An example of an atmospheric pressure plasma reactor for performing PACVD is the dielectric barrier discharge reactor 4, depicted in FIG. 1. It comprises at least one set of electrodes 1, at least one of which is covered by a layer 2 of dielectric material. The power supply 3 is connected to at least one of the electrodes. The other electrode can be grounded, connected to the power supply 3, connected to a second power supply or connected to the same power supply with an (90°) out of phase potential. An inlet port is provided with possibly a control valve 5 for the gases coming from a gas supply unit 6 for establishing the plasma atmosphere (e.g. nitrogen gas). An aerosol generator 9 is provided, possibly with a control valve 13, for supplying an aerosol comprising a coating forming material (and possibly the second biocidal material) into the plasma discharge. The plasma gas supply 6 also acts as carrier gas supply for carrying the aerosol into the reactor. The reactor further comprises a pump 7 to evacuate the gases, possibly with a control valve 8. Voltage, charge and current measurements can be performed by means of an oscilloscope 10. For this, one can use respectively a voltage probe 12, a capacitor 11 and a current probe. Conditions to create a plasma are a frequency between 50 Hz and 10 MHz, a power range between 0.05 W/cm² and 100 W/cm², and an electrode gap between 0.01 mm and 100 mm.

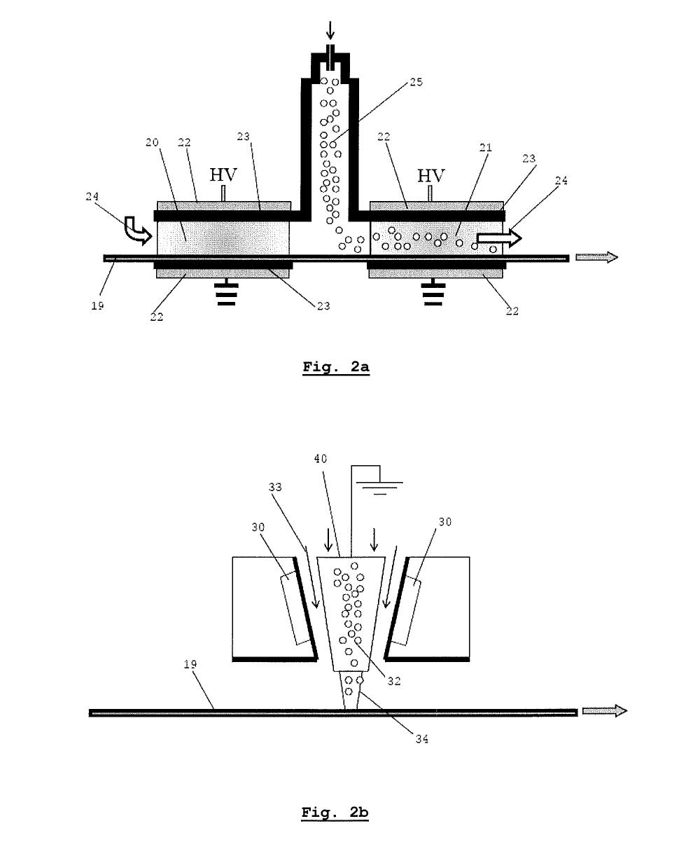

FIG. 2a describes another possible DBD-setup, for a continuous coating deposition, wherein the substrate is a foil 19 which is supplied through a first plasma discharge 20 and a second discharge 21, each plasma discharge taking place between a pair of electrodes 22, with a dielectric layer 23 on at least one electrode of each electrode pair (and powered as described above). Plasma gas (e.g. nitrogen) is supplied from left to right (see arrows 24), and an aerosol 25 comprising coating forming material (and possibly a second biocidal material) is introduced in the space between the two plasma discharges. The coating forming material is thus introduced in the second discharge 21 to thereby coat the substrate, whereas the first discharge performs a pre-treatment on the substrate.

FIG. 2b shows another possible DBD setup, usable also for coating a continuous substrate 19, where a dielectric barrier discharge is created between a pair of electrodes 30, at least one of which being provided with a dielectric layer 31 and placed on either side of a grounded hollow electrode 40. An aerosol 32 comprising a coating forming material (and possibly a second biocidal material) is injected through the hollow interior of the grounded electrode 40, from top to bottom, while the plasma gas 33 (acting also as carrier gas, e.g. nitrogen gas) is injected in the space between the grounded electrode 40 and the dielectric layers 31. At the bottom of the electrode pair, the gas stream 34 (also referred to as the ‘afterglow’) resulting from the plasma discharge appears. In this embodiment, the substrate is exposed not to the discharge itself, but to the reactive gas stream 34, to thereby produce a coating on the substrate 19.

Suitable parameters that can be applied in the set-up of FIG. 2b are:

application of a solution of 10 g AgNO₃ in 100 ml APEO, in the form of an aerosol, by 2 atomizers,

aerosol generated by nitrogen carrier gas at 1.51/min followed by additional thinning with nitrogen gas as 101/min, per atomizer

aerosol flow rate (i.e. flow rate of solution APEO+AgNO3 towards the two atomizers: 60 μl/min

aerosol diameter: about 30 nm

frequency: 48 kHz

power: 8.5 W/cm²

plasma gas supply: nitrogen at 6001/min

distance substrate/reactor=4 mm

substrate speed: 4 m/min. The preferred ranges of the above parameters may depend on the type of discharge, dimensions of the reactor and other factors. A few preferred ranges are given hereafter:

Flow rate of plasma gas: between 1 and 10001/min
Flow rate of carrier gas per atomizer: between 0.5 and 101/min
Aerosol flow rate: between 0.1 and 1000 μl/min.

Besides the dielectric barrier discharge, other techniques for generating a PACVD deposition may be used, such as for example a RF or microwave glow discharge, a pulsed discharge or a plasma jet. As is clear to the skilled reader, depending on the application, further adjustments concerning for example mechanical strength or deposition rate can be achieved by applying an intermediate pressure (0.1 to 1 bar) instead of an atmospheric pressure.

Suitable PACVD installations can be used which allow to deposit a layer by introducing only a biocidal material into the plasma discharge or the afterglow. Such installations can be used in the first embodiment (FACVD+PACVD) to form in the PACVD step a layer of biocidal material with a coating on top of the biocidal layer, or in the second embodiment (PACVD+FACVD) to form in the PACVD step a layer of biocidal material with the FACVD layer directly on top of that PACVD-deposited biocidal layer.

An aerosol can be generated with liquids, solutions or sol-gel. Examples of aerosol generators are ultrasonic nebulizers, bubblers or electrospraying techniques. As is clear to the skilled person, depending on the application, a different method for injection of the coating forming material may be necessary. Electrostatic spraying techniques allow to charge or discharge the coating forming material before entering the plasma. The precursor can also be injected as a gas or a vapor.

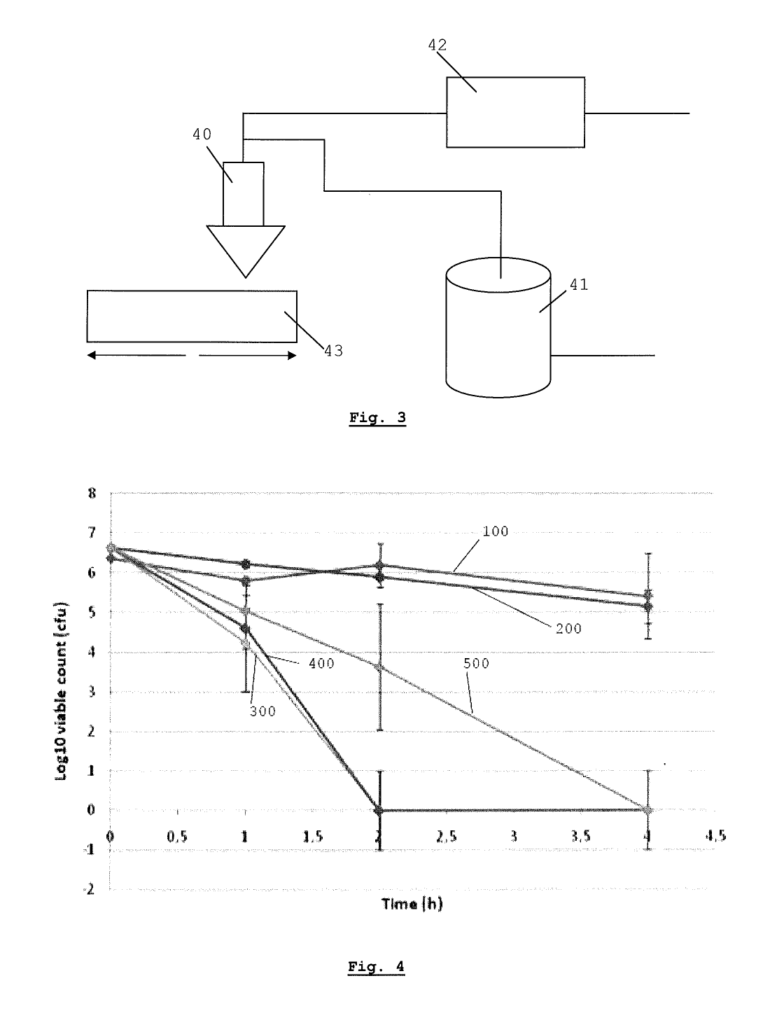

FIG. 3 shows a schematic view of an FACVD tool, comprising a flame head 40, bubbler 41, nebulizer 42 and movable substrate support table 43.

The following is an example of parameters that may be used in the installation of FIG. 3: TEOS is heated to 110 degrees in the bubbler and picked up by a flow of 0.5 L/min nitrogen and swept along heated lines set at 120 degrees, to join with nebulised vapours delivering 0.0083 ml/s from a 0.05M silver nitrate solution (AgNO3 in water) picked up by 3 L/min of nitrogen gas. The substrate moves at a translation speed of 6.5 cm/s. The gases enter the flame head which is burning a mixture of 1 L/min propane 19 L/min air. The subsequent film is produced on either steel/coated steel or glass substrates at ambient temperature. The substrate is translated under the flame at a controlled speed, using a stepper motor to provide thickness in the desired range.

The invention is equally related to a substrate obtainable by the method of the invention. Such a substrate is characterized by the presence on its surface of a double coating structure, as a result of the FACVD and PACVD steps. According to a first embodiment, the coating structure consists of an FACVD-coating portion with a PACVD coating portion on top, i.e. the FACVD coating portion is on and in contact with the substrate surface and the PACVD portion is on and in contact with the FACVD portion. The FACVD applied portion of the coating may comprise a coating material on top of a biocidal material or a coating material with a biocidal material incorporated therein. For example the FACVD-coating portion may be a SiO₂ layer on top of a layer or areas comprising Ag (the Ag obtained by FACVD-deposition of AgNO₃, the SiO₂ obtained by subsequent FACVD-deposition of TEOS), or the FACVD coating portion may be areas comprising Ag and no coating material. Or still alternatively, the FACVD coating portion may be a SiO₂ layer with Ag embedded therein. The PACVD coating portion comprises a coating material deposited by the PACVD step, for example a Si-based organic coating, possibly further comprising biocidal materials, such as Ag embedded in the organic coating. According to a second embodiment, the coating structure consists of a PACVD coating portion with a FACVD coating portion on top, i.e. the PACVD coating portion is on and in contact with the substrate surface and the FACVD portion is on and in contact with the PACVD portion. A substrate obtained by the method of the invention may reach excellent biocidal properties without requiring a pre-treatment (such as a sterilization) of the substrate. According to a preferred embodiment, a substrate according to the invention preferably has no CVD-obtained or CVD-obtainable layer underneath the first and second coating portion, such as a SiO₂ diffusion barrier layer. According to another embodiment, the coating material of the second coating portion does not have biocidal properties.

The invention is equally related to the use of the method of the invention for giving biocidal properties to any type of substrate, such as polyester-coated or lacquered steel panels for use in hospital environments, steel panels for air-conditioning applications, plastic foils, or other substrates (see above).

### EXAMPLES

A number of experiments and corresponding test results are described hereafter and illustrated by the curves in FIG. 4. The invention is not limited by the details of these tests, but only by the appended claims.

Curve 100 represents a comparative example (i.e. according to a prior art method), of a substrate treated by the following method:
Providing a polyester coated steel substrate,
exposing the substrate to the afterglow of a plasma discharge of the dielectric barrier discharge (DBD) type at atmospheric pressure, in an installation as shown in FIG. 2b,
while the substrate is exposed to said discharge-afterglow, introducing—by aerosol-injection—a solution into said discharge, the solution consisting of a liquid organosilicon precursor of the type aminopropyltriethoxysilane (APEO), with particles of AgNO₃ dissolved therein.

Curve 200 represents a second comparative example (according to a prior art method) of a substrate treated as follows:
providing a polyester coated steel substrate
subjecting the substrate to an FACVD step (as in FIG. 3), by introducing simultaneously an organosilicon precursor (TEOS, introduced as aerosol) and a AgNO₃ solution (AgNO₃ in water) into a flame obtained from a mixture of air and propane (191/min air and 11/min propane).

Both obtained coatings comprise a coating material, with anti-microbial Ag embedded in the coating material. In the DBD-plasma-deposited coating, the organic part of the APEO-precursor is substantially maintained, and the resulting coating is flexible. In the coating obtained by FACVD, the coating material comprises mainly SiO₂ as the organic part of the precursor is burnt out. The latter coating has a higher hardness.

The antimicrobial properties of both coatings are illustrated by curves 100 and 200 (results of bacteria count of Escherichia coli bacteria). Both show a Log 10 viable count reduction of 7 after 24 hrs (i.e. after 24 hrs, 10⁷ less bacteria are on the surface). However, no significant efficiency is visible after a short period of 4 hrs. This result is open to improvement in view of the growing demands on antimicrobial efficiency.

The curves 300, 400 and 500 represent test results obtained by the method of the invention.

Curve 300 represents a substrate treated as follows:
providing a polyester coated steel substrate,
subjecting the substrate to an FACVD step (as in FIG. 3), by introducing simultaneously an organosilicon precursor (TEOS, introduced as aerosol) and a AgNO₃ solution (AgNO₃ in water) into a flame obtained from a mixture of air and propane (191/min air and 11/min propane),
thereby obtaining a coated substrate with a hard SiO₂ coating thereon, comprising Ag embedded in said coating,
exposing the substrate to the afterglow of a plasma discharge of the dielectric barrier discharge (DBD) type at atmospheric pressure, in an installation as shown in FIG. 2b,
while the substrate is exposed to said discharge-afterglow, introducing—by aerosol-injection—a solution into said discharge, the solution consisting of a liquid organosilicon precursor of the type aminopropyltriethoxysilane (APED), with particles of AgNO₃ dissolved therein.

Curve 400 represents a substrate treated as follows:
providing a polyester coated steel substrate,
subjecting the substrate to an FACVD step (as in FIG. 3), by introducing a AgNO₃ solution (AgNO₃ in water) into a flame obtained from a mixture of air and propane (191/min air and 11/min propane),
thereby obtaining a coated substrate, consisting of the substrate having an Ag-containing coating,
exposing the substrate to the afterglow of a plasma discharge of the dielectric barrier discharge (DBD) type at atmospheric pressure, in an installation as shown in FIG. 2b,
while the substrate is exposed to said discharge-afterglow, introducing—by aerosol-injection—a solution into said discharge, the solution consisting of a liquid organosilicon precursor of the type aminopropyltriethoxysilane (APEO), with particles of AgNO₃ dissolved therein.

Curve 500 represents a substrate treated as follows:
providing a polyester coated steel substrate
subjecting the substrate to an FACVD step (as in FIG. 3), by introducing a AgNO₃ solution (AgNO₃ in water) into a flame obtained from a mixture of air and propane (1901/min air and 101/min propane),
thereby obtaining a coated substrate, consisting of the substrate having a coating of Ag thereon,
exposing the substrate to the afterglow of a plasma discharge of the dielectric barrier discharge (DBD) type at atmospheric pressure, in an installation as shown in FIG. 2b,
while the substrate is exposed to said discharge-afterglow, introducing—by aerosol-injection—a liquid organosilicon precursor of the type aminopropyltriethoxysilane (APEO), without any further biocidal materials therein.

The results are illustrated by the curves 300-400-500. Coatings 300 and 400 show a Log 10 viable count of 7 in 2 hrs. Coating 500 shows a Log 10 viable count of 7 in 4 hrs. These results are significantly better than the results obtained by coatings 100 and 200.

It is to be noted that the test results shown in FIG. 4 were obtained by a biocidal testing technique as known in the art (e.g. according to standard test BS EN 13697:2001), without applying a sterilisation of the test samples before biocidal activity testing.

These results show that the addition of a PACVD step onto a Ag-comprising FACVD coating leads to an unexpected rise in biocidal activity. The scope of the invention is defined only by the claims and not by the materials or methods cited above. What the invention generally brings to the present state of the art is a method for providing a biocidal coating on a substrate, wherein first a flame-assisted plasma biocidal coating step is applied to a substrate, and wherein that step is followed by a second coating step, using a PACVD step, wherein preferably a second biocidal material is added during the second coating step. According to a second embodiment, the first step is a plasma-assisted biocidal coating step, followed by a FACVD step, wherein preferably a second biocidal material is added.

1. A method for producing a coating on a substrate, comprising the subsequent steps of:
providing a substrate,
subjecting the substrate to a flame-assisted chemical vapour deposition (FACVD), by exposing the substrate to a flame or the gas stream resulting therefrom and by introducing a first biocidal material into said flame or the reactive gas stream resulting therefrom, and by introducing a first coating-forming material into the flame or the gas stream resulting therefrom, said first coating forming material being introduced simultaneously with or after said first biocidal material,
subjecting the substrate to a plasma-assisted chemical vapour deposition (PACVD) at atmospheric or intermediate pressure, by exposing the substrate to a plasma discharge or the reactive gas stream resulting therefrom and by introducing a second coating-forming material into said discharge or the reactive gas stream resulting therefrom, wherein the second coating forming material comprises an organosilicon precursor.

2. The method according to claim 1, wherein a second biocidal material is introduced into the plasma discharge or the reactive gas stream resulting therefrom, said second coating forming material being introduced simultaneously with or after said second biocidal material.

3. A method for producing a coating on a substrate, comprising the subsequent steps of:
providing a substrate,
subjecting the substrate to a plasma-assisted chemical vapour deposition (PACVD) at atmospheric or intermediate pressure, by exposing the substrate to a plasma discharge or the reactive gas stream resulting therefrom and by introducing a first biocidal material into said discharge or the reactive gas stream resulting therefrom, and by introducing a first coating-forming material into said discharge or the gas stream resulting therefrom, said first coating forming material being introduced simultaneously with or after said first biocidal material,
subjecting the substrate to a flame-assisted chemical vapour deposition (FACVD), by exposing the substrate to a flame or the gas stream resulting therefrom and by introducing a second coating-forming material into the flame or the gas stream resulting therefrom, wherein the second coating forming material comprises an organosilicon precursor.

4. The method according to claim 3, wherein a second biocidal material is introduced into the flame or the reactive gas stream resulting therefrom, said second coating forming material being introduced simultaneously with or after said second biocidal material.

5. The method according to claim 1, wherein said first coating-forming material comprises an organosilicon precursor.

6. The method according to claim 1, wherein said organosilicon precursor is APEO or TEOS.

7. The method according to claim 1, wherein the first coating-forming material has biocidal properties.

8. The method according to claim 7, wherein the first coating forming material when deposited by PACVD is chosen from the group consisting of: allyl amine, butylamine, hexamethyldisilazane, 3-aminopropyltriethoxysilane, N-(2-Aminoethyl)-3-aminopropyltriethoxysilane, 3-aminopropyltrimethoxysilane, triazine, 2,4-diamino-6-diallylamino-1,3,5-triazine, dimethylhydantoin, methyl quaternized N,N-dimethylamino-O-ethyl-methacrylate, methyl quaternized N,N-benzyl-methylamino-O-ethyl-methacrylate, diallyldimethylammonium chloride, quaternized vinylbenzylchloride, tetra-n-butyl ammonium chloride, 3-((trimethoxysilyl)propyl) octadecyldimethylammonium chloride, diallyldisulphide, mercaptopropyl trimethoxysilane, and mercaptopropyl triethoxysilane.

9. The method according to claim 1, wherein the first and/or the second biocidal material comprises one or more of the following: silver, copper, titanium, mercury, tin, lead, bismuth, chromium, cobalt, nickel, tallium, cadmium, zinc, magnesium, silver nitrate, copper sulfate, copper nitrate, silver sulphate.

10. The method according to claim 1, wherein said plasma discharge is a dielectric barrier discharge (DBD).

11. The method according to claim 1, wherein at least the second coating forming material does not have biocidal properties, or does not comprise a biocidal component.

12. A coated substrate comprising:
a substrate having a surface,
on and in contact with said substrate surface, a first coating portion obtainable by flame-assisted chemical vapour deposition (FACVD), said first coating portion comprising a first biocidal material,
on and in contact with said first coating portion, a second coating portion obtainable by plasma-assisted chemical vapour deposition (PACVD), the second coating portion comprising a coating material comprising a silicon compound.

13. The coated substrate according to claim 12, wherein the second coating portion further comprises a second biocidal material.

14. A coated substrate, comprising:
a substrate having a surface,
on and in contact with said substrate surface, a first coating portion obtainable by plasma-assisted chemical vapour deposition (PACVD), said first coating portion comprising a first biocidal material,
on and in contact with said first coating portion, a second coating portion obtainable by flame-assisted chemical vapour deposition (FACVD), the second coating portion comprising a coating material comprising a silicon compound.

15. The coated substrate according to claim 14, wherein the second coating portion further comprises a second biocidal material.

16. The coated substrate according to claim 12, wherein said coating material of the second coating portion does not have biocidal properties.

17. The coated substrate according to claim 12, wherein said first coating portion comprises a coating material covering one or more areas comprising said biocidal material, or said biocidal material being incorporated into said coating material.
